(19) United States
(12) Patent Application Publication
(10) Pub. No.: US 2026/0224999 A1
(43) Pub. Date: Aug. 6, 2026

(54) VAPOR-LIQUID CONTACT TRAY WITH CANS AND SWIRLERS IN THE CANS AND METHOD

(71) Applicant: Koch-Glitsch, LP, Wichita, KS (US)

(72) Inventors: Izak Nieuwoudt, Wichita, KS (US); Charles A Griesel, Wichita, KS (US)

(21) Appl. No.: 19/156,423

(22) PCT Filed: Feb. 28, 2024
(86) PCT No.: PCT/IB2024/051918

§ 371 Date: Aug. 14, 2025

Related U.S. Application Data
(60) Provisional application No. 63/449,191, filed on Mar. 1, 2023.

(51) Int. Cl. B01D 3/20

(52) U.S. Cl. CPC B01D 3/20

(57) ABSTRACT

A contact tray is provided with a tray deck and dividing walls which isolate an upstream side of one or more cans on the tray from a downstream side of the cans. A tunnel extends into the upstream side of each can from the tray deck to deliver liquid from the tray deck onto a lower swirler that may be positioned within the can below a level of the tray deck. The lower swirler imparts a centrifugal swirling motion to vapor that ascends within each can to cause mixing of the liquid and vapor within the can. Discharge openings are provided in the downstream side of the cans to allow the liquid to exit the cans after mixing with the vapor. The vapor then exits out an open top of each can.

### RELATED APPLICATION

This application claims the benefit of U.S. Provisional Patent Application No. 63/449,191 filed on Mar. 1, 2023, which is hereby incorporated by reference in its entirety.

### BACKGROUND

The present disclosure relates to chemical processing columns in which mass transfer and/or heat exchange between fluid streams occurs and, more particularly, to vapor-liquid contact trays used in such columns to facilitate contact between fluid streams flowing within the column and methods of contacting the fluid streams using the contact trays.

Contact flow trays are used within mass transfer and heat exchange columns to facilitate contact between fluid streams flowing in countercurrent relationship within the column. As used herein, the term “mass transfer column” is intended to refer to columns in which mass transfer, heat exchange or mass transfer and heat exchange are intended to occur. The fluid streams are typically an ascending vapor stream and a descending liquid stream, in which case the contact trays are commonly referred to as vapor-liquid contact trays. In some applications, both fluid streams are liquid streams and the contact trays are commonly referred to as liquid-liquid contact trays. In still other applications, the ascending fluid stream is a gas stream and the descending fluid steam is a liquid stream, in which case the contact trays are referred to as gas-liquid contact trays.

The contact trays each have a planar tray deck on and above which interaction between the ascending fluid stream and the descending fluid stream occurs, a plurality of openings to allow upward passage of the ascending fluid stream through the tray deck and into the descending fluid stream to create a froth or mixture in which the desired mass transfer and/or heat exchange occurs, and at least one downcomer that directs the descending fluid stream from the associated tray deck to a tray deck on an underlying contact tray. The contact trays are positioned within the mass transfer column in vertically spaced-apart relationship with each of the tray decks extending horizontally to fill the entire internal cross-section of the mass transfer column.

One type of vapor-liquid contact tray developed for high fluid flow capacity and high efficiency applications uses a plurality of upright cylindrical cans on the tray deck to enhance the mixing of the vapor and liquid streams. The cans extend upwardly from the tray deck and surround vapor openings formed in the tray deck. Swirl vanes positioned within each cylindrical can impart a swirling motion to the vapor ascending within the can. In one embodiment, a downcomer directs liquid from an overlying tray into the center of each can where it is picked up by the swirling vapor to cause vigorous vapor-liquid interaction that leads to high separation efficiency and subsequent disengagement of the liquid phase from the vapor phase. In another embodiment, the liquid flowing along the tray deck enters each can through one or more openings in the outer perimeter wall that forms the can.

The centrifugal force imparted to the liquid by the swirling vapor within the can causes the liquid to splash against and rise along the inner wall surface of the can. Openings in the inner wall surface allow the liquid to pass through the inner wall surface and then descend onto the tray deck. The liquid travels along the tray deck and enters an opening in the tray deck that forms an inlet to a downcomer that directs the liquid into a can on an underlying contact tray or onto the tray deck of the underlying contact tray. The swirling vapor exits the can through an open top of the can and then ascends into and through an opening surrounded by a can in the tray deck of an overlying contact tray. In this manner, the vapor stream ascends, and the liquid stream descends from can to can in successive contact trays.

### BRIEF DESCRIPTION

This brief description is provided to introduce a selection of concepts in a simplified form that are further described in the detailed description below. This brief description is not intended to identify key features or essential features of the claimed subject matter, nor is it intended to be used to limit the scope of the claimed subject matter. Other aspects and advantages of the present disclosure will be apparent from the following detailed description of the embodiments and the accompanying figures.

In one aspect, the present disclosure is directed to a contact tray for facilitating contact between ascending and descending fluids within a mass transfer column. The contact tray comprises: a tray deck; two or more cans positioned on and extending upwardly from the tray deck, each of said cans having a generally open top and being formed by an outer perimeter wall of a preselected height from a lower end to an upper end, said outer perimeter wall having a plurality of discharge openings extending through the wall to allow fluid to pass through the wall from within the can; openings extending through the tray deck within areas circumscribed by each of the cans to allow fluid to pass upwardly through the tray deck within the cans; a lower swirler positioned to cause centrifugal swirling of the fluid as it passes upwardly within the cans; a downcomer extending downwardly from the tray deck and comprising a downcomer inlet formed by an inlet opening in the tray deck outside of the areas circumscribed by the cans for removing liquid from the tray deck and conveying it downwardly and a lower discharge outlet for removing the liquid from the downcomer; an inlet area on the tray deck outside of the areas circumscribed by the cans for receiving liquid when discharged onto the tray deck from above; at least one tunnel constructed to provide a passageway to deliver liquid from the tray deck onto the lower swirler, the tunnel having a tunnel inlet that is positioned at an opening in the outer perimeter wall of the can above the tray deck to allow liquid on the tray deck to enter the tunnel and a discharge outlet that is positioned to discharge descending liquid from within the tunnel onto or adjacent the lower swirler to interact with the centrifugally-swirling fluid; and one or more dividing walls extending upwardly from the tray deck and positioned to direct the liquid when received on the inlet area of the tray deck to the tunnel inlets of the cans and then from the cans to the downcomer inlet of the downcomer.

In another aspect, the present disclosure is directed to a mass transfer column comprising: an upright external shell that defines an open internal region; and a plurality of the horizontally-extending contact trays described above positioned in vertically-spaced relationship within the open internal region.

In a further aspect, the present disclosure is directed to a method of operating a mass transfer column comprising an upright external shell that defines an open internal region and a plurality of horizontally-extending contact trays positioned in vertically-spaced relationship within the open internal region, each of said contact trays comprising a tray deck, a plurality of cans extending upwardly from the tray deck, a downcomer extending downwardly from the tray deck and having a downcomer inlet at said tray deck, and dividing walls that extend upwardly from the tray deck and isolate an upstream front side of each can from a downstream back side of each can to block fluid on the tray deck from flowing around each can from the front side to the back side. The method comprises the steps of: delivering a first fluid downwardly through the downcomer extending downwardly from one of said contact trays and discharging the first fluid from said downcomer onto an inlet area on a tray deck of an underlying contact tray; flowing the first fluid from the inlet area along the tray deck and into the cans through a tunnel having a tunnel inlet that is positioned at an opening in an outer perimeter wall of each of the cans above the tray deck; flowing the first fluid in the tunnel downwardly and discharging it from the tunnel onto or adjacent the lower swirler; interacting with a swirling motion the first fluid discharged from the tunnel with a second fluid that ascends through the tray deck and the lower swirler within the cans on said underlying contact tray; removing said first fluid from within said cans after interaction with said second fluid; and directing said removed first fluid from the one or more cans and delivering it to the downcomer inlet.

### BRIEF DESCRIPTION OF THE DRAWINGS

The present disclosure is described in detail below with reference to the attached drawing figures, wherein:

FIG. 1 is a perspective view of a mass transfer column with a portion of an external shell of the mass transfer column broken away to illustrate a first embodiment of contact trays of the present disclosure positioned within an open internal region of the mass transfer column with two upright cans positioned on a tray deck of each of the contact trays;

FIG. 2 is a fragmentary side elevation view of the mass transfer column taken in vertical section through the mass transfer column and through the upright cans that are positioned on the tray decks of the contact trays;

FIG. 3 is a perspective view of two of the contact trays;

FIG. 4 is a perspective view of the two contact trays shown in FIG. 3 but taken from an opposite side;

FIG. 5 is a top perspective view of a front or upstream side of one of the upright cans;

FIG. 6 is a top perspective view of the upright can shown in FIG. 5 but with portions of an outer perimeter wall of the upright can broken away to show internal details;

FIG. 7 is a bottom perspective view of the upstream side of the upright can shown in FIGS. 5 and 6;

FIG. 8 is a top plan view of one of the contact trays;

FIG. 9 is a top plan view of a second embodiment of a contact tray of the present disclosure;

FIG. 10 is a top plan view of a third embodiment of a contact tray of the present disclosure that is in the form of a single-pass cross-flow tray;

FIG. 11 is a top plan view of a fourth embodiment of a contact tray of the present disclosure that is in the form of a center-to-side, two-pass cross-flow tray; and

FIG. 12 is a top plan view of a fifth embodiment of a contact tray of the present disclosure that is in the form of a side-to-center, two-pass cross-flow tray intended to be used in alternating vertical relationship with the center-to-side, two-pass cross flow tray shown in FIG. 11.

### DETAILED DESCRIPTION

The subject matter of the present disclosure is described with specificity herein to meet statutory requirements. However, the description itself is not intended to limit the scope of this patent. Rather, the inventors have contemplated that the claimed subject matter might also be embodied in other ways, to include different components, combinations of components, steps, or combinations of steps similar to the ones described in this document, in conjunction with other present or future technologies.

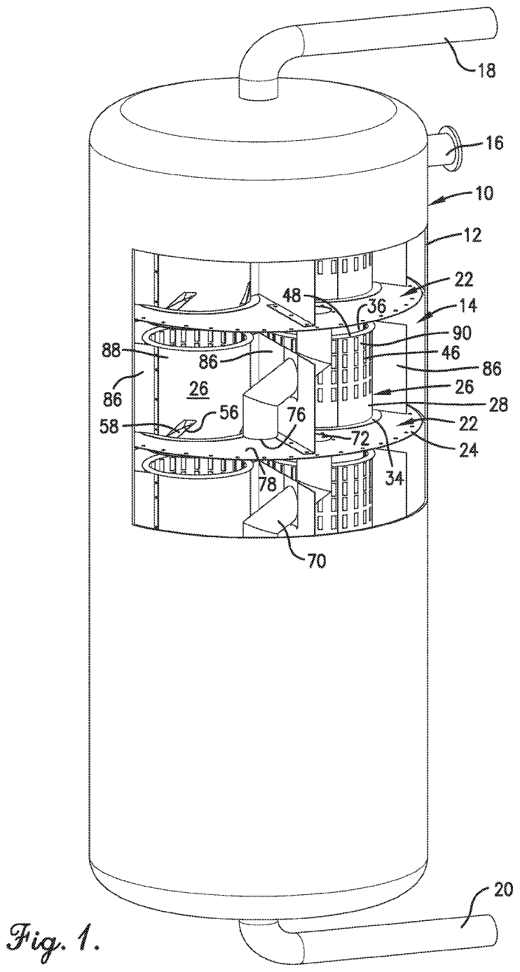

Turning now to the drawings in greater detail and initially to FIG. 1, a mass transfer column suitable for use in processes in which mass transfer and/or heat exchange is intended to occur between countercurrent-flowing fluid streams is represented generally by the numeral 10. Mass transfer column 10 includes an upright, external shell 12 that is generally cylindrical in configuration, although other configurations, including polygonal, are possible and are within the scope of the present invention. Shell 12 is of any suitable diameter and height and is constructed from one or more rigid materials that are desirably inert to or are otherwise compatible with the fluids and conditions present during operation of the mass transfer column 10.

Mass transfer column 10 is of a type used for processing fluid streams, typically liquid and vapor streams, to obtain fractionation products and/or to otherwise cause mass transfer and/or heat exchange between the fluid streams. For example, mass transfer column 10 can be one in which crude atmospheric, lube vacuum, crude vacuum, fluid or thermal cracking fractionating, coker or visbreaker fractionating, coke scrubbing, reactor off-gas scrubbing, gas quenching, edible oil deodorization, pollution control scrubbing, and other processes occur. The mass transfer column 10 may be positioned on land or it may be positioned offshore, such as on a floating platform, barge or ship.

The shell 12 of the mass transfer column 10 defines an open internal region 14 in which the desired mass transfer and/or heat exchange between the fluid streams occurs. Normally, the fluid streams comprise one or more ascending vapor streams and one or more descending liquid streams. Alternatively, the fluid streams may comprise both ascending and descending liquid streams or an ascending gas stream and a descending liquid stream.

The fluid streams are directed to the mass transfer column 10 through any number of feed lines 16 positioned at appropriate locations along the height of the mass transfer column 10. One or more vapor streams may also be generated within the mass transfer column 10 rather than being introduced into the mass transfer column 10 through the feed lines 16. The mass transfer column 10 will also typically include an overhead line 18 for removing a vapor product or byproduct and a bottom stream takeoff line 20 for removing a liquid product or byproduct from the mass transfer column 10. Other mass transfer column components that may be present, such as reflux stream lines, reboilers, condensers, vapor horns, and the like, are not illustrated in the drawings because they are conventional in nature and an illustration of these components is not believed to be necessary for an understanding of the present disclosure.

A plurality of horizontally extending contact trays 22 of a first embodiment are positioned in vertically-spaced relationship within the open internal region 14 of the mass transfer column 10. The contact trays 22 include a tray deck 24 that may be constructed from a number of individual panels that are joined together in any of various known fashions. The tray deck 24 is intended to extend horizontally across all, or substantially all, of the internal cross section of the mass transfer column 10.

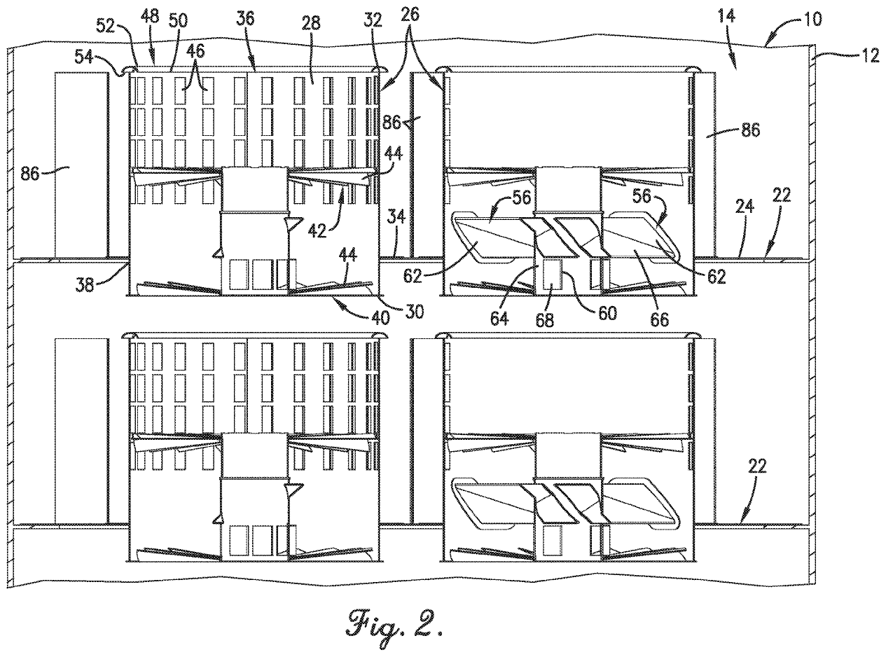

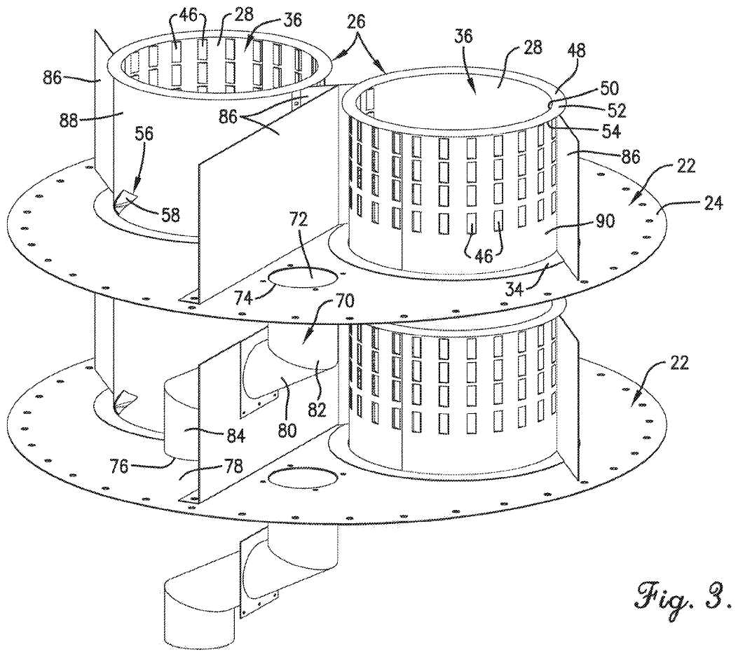

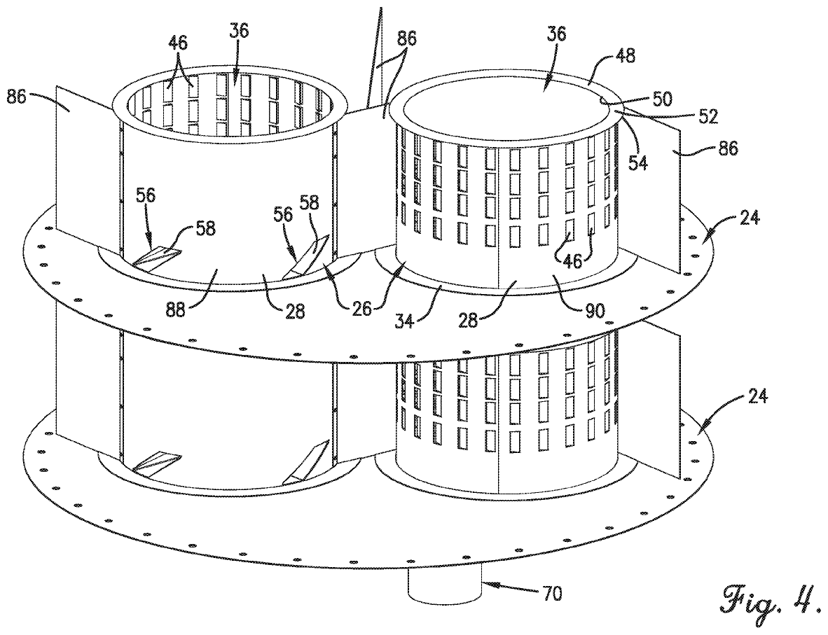

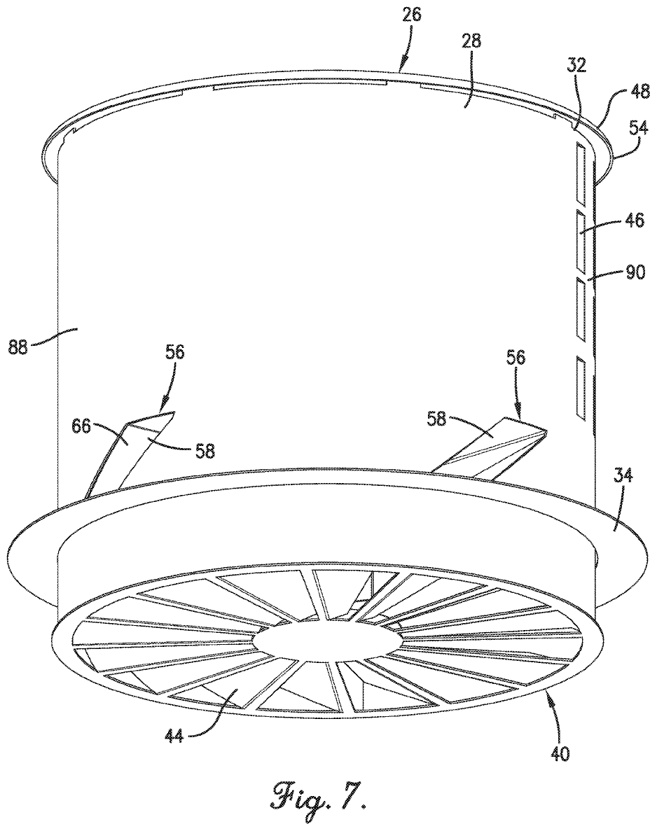

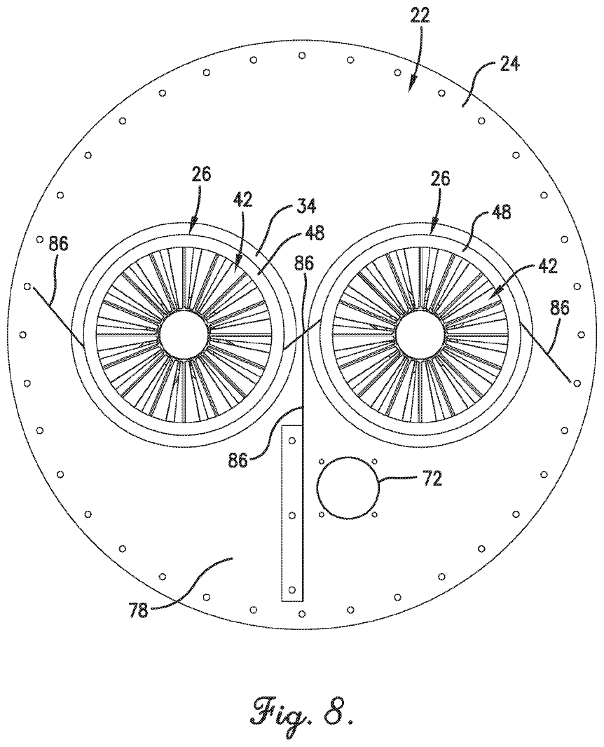

Turning additionally to FIGS. 2-8, each of the contact trays 22 includes a plurality of upright cans 26 that are laid out in a preselected pattern and are supported by the tray deck 24. The upright cans 26 extend upwardly a preselected distance from the tray deck 24 and in some embodiments may also extend a lesser distance below the tray deck 24. Each can 26 is formed by an outer perimeter wall 28 of a preselected height between a lower end 30 and an upper end 32. The outer perimeter wall 28 is normally of a generally cylindrical configuration, although polygonal and other configurations may be used. Each outer perimeter wall 28 is secured to the tray deck 24 of the contact tray 22 in any suitable fashion, such as by bolting, welding or other means. In one embodiment, a flat, annular ring 34 surrounds the outer perimeter wall 28 and is secured to the outer perimeter wall 28 and to the tray deck 24.

The outer perimeter walls 28 may have a portion that extends below the tray deck 24. The height of the portion of each outer perimeter wall 28 of each can 26 above the tray deck 24 is less than the vertical spacing between adjacent contact trays 22 so that the upper end 32 of each outer perimeter wall 28 is spaced a preselected distance below the overlying contact tray 22 to allow the ascending vapor or liquid stream to exit through the open or generally open top 36 of each can 26.

Normally, the height of each outer perimeter wall 28 above the tray deck 24 is at least one-half, or more preferably at least two-thirds, of the vertical spacing between adjacent contact trays 22. Each outer perimeter wall 28 is normally the same height as the other walls 28 of the cans 26 on the same contact tray 22, but the outer perimeter walls 28 may be of varying height if desired for particular applications. The height of the outer perimeter walls 28 of the cans 26 on one contact tray 22 may be the same as or different from the height of the outer perimeter walls 28 of the cans 26 on other contact trays 22. In one embodiment, the cans 26 on each contact tray 22 are in vertical alignment with cans 26 on vertically adjacent contact trays 22. In another embodiment, the cans on each contact tray 22 are not in vertical alignment with cans 26 on vertically adjacent contact trays 22.

The contact trays 22 also include openings 38 formed in the tray deck 24 to allow the ascending vapor or other fluid stream to pass upwardly through the tray deck 24. In one embodiment, all, or substantially all, of the openings 38 are positioned within the area enclosed by the outer perimeter walls 28 of the cans 26 so that all, or substantially all, of the vapor or other fluid stream passing upwardly through the tray deck 24 ascends through the cans 26. A single, large opening 38 may be enclosed by the outer perimeter wall 28 of each can 26, or multiple smaller openings 38 may be enclosed by the outer perimeter wall 28 of each can 26. The number and diameter of the cans 26 and the size of the openings 38 are selected to provide the desired vapor or other fluid stream flow capacity and the desired volume for the intended vapor-liquid or other fluid-fluid interaction within that portion of the mass transfer column 10 in which the contact trays 22 are positioned.

A lower swirler 40 is positioned within each can 26 at a location at or below the level of the tray deck 24 so that vapor or other fluid that ascend into the lower end 30 of each can 26 must pass through the lower swirler 40 as it ascends within the can 26. The lower swirler 40 imparts a centrifugal swirling motion to the ascending vapor or other fluid stream. In one embodiment, an upper swirler 42 is also provided within each can 26 and is positioned at a location spaced above the lower swirler 40 to cause additional centrifugal swirling of the ascending vapor or other fluid as well as the entrained liquid or other fluid as described below.

Each of the lower swirlers 40 and upper swirlers 42 comprises a plurality of radially-extending vanes 44 that may be planar, curved or other configurations. The vanes 44 in the lower swirlers 40 may be shaped and/or angled the same as or differently from the vanes 44 in the upper swirlers 42. As one example, the vanes 44 in the lower swirlers 40 may be curved to provide a gradual transition for the ascending vapor or other fluid stream from a vertical flow direction to one with a substantial radial, tangential, or rotational flow vector. Because the vanes 44 in the upper swirlers 42 are presented with the ascending vapor or other fluid stream and entrained liquid or other fluid flowing with the radial flow vector, the vanes 44 in the upper swirlers 42 may be planar or formed with less of a curve in comparison to the vanes 44 in the lower swirlers 40.

The lower swirlers 40 and the upper swirlers 42 may be oriented so that the vapor or other fluid stream and the entrained liquid swirls in the same rotational direction in each can 26 on each tray deck 24. Alternatively, the direction of vapor or other fluid stream rotation in some cans 26 may be different from that in other cans 26. For example, the vapor or other fluid stream rotation may be clockwise (when viewed from above) in each can 26 on one tray deck 24 and counterclockwise in each can 26 on an adjacent tray deck 24. As another example, the direction of vapor or other fluid stream rotation may be clockwise in some cans 26 on one tray deck 24 and counterclockwise in the other cans 26 on the same tray deck 24.

The cans 26 each include a plurality of discharge openings 46 in the outer perimeter walls 28 of the cans 26 to permit the liquid within the cans 26 to exit the cans 26 through the discharge openings 46 following interaction with the swirling vapor or other fluid stream in the cans 26. The discharge openings 46 may be of various forms, such as simple holes, directional louvers that extend into the cans 26 as illustrated in the drawings, and outwardly bent tabs (not shown) that are angled downwardly to deflect exiting liquid in a downward direction toward the tray deck 24. Other embodiments of the discharge openings 46 are contemplated by and are within the scope of the present invention. As explained more fully below, the discharge openings 46 may be positioned in only a downstream side of each can 26.

A downturned lip ring 48 may be positioned at the upper end 32 of the outer perimeter wall 28 in each can 26 to capture any portion of the liquid that exits along the upper end 32 of the outer perimeter wall 28 and redirect the captured liquid outside of the can 26 and downwardly toward the tray deck 24. The lip ring 48 may have an inner segment 50 that is positioned inwardly of the outer perimeter wall 28 of the associated can 26, a curved upper segment 52 spaced slightly above the top edge of the wall 28, and an outer segment 54 that is positioned outside of the outer perimeter wall 28 to direct the captured liquid downwardly toward the tray deck 24. The lip ring 48 may be integrally formed with the outer perimeter wall 28 or may be formed separately and secured to the outer perimeter wall 28 in a suitable fashion.

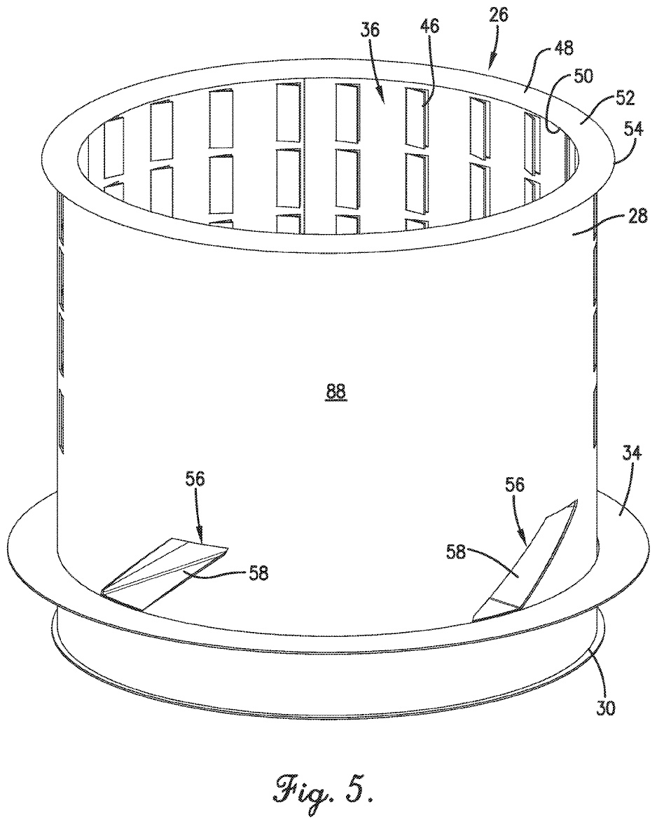

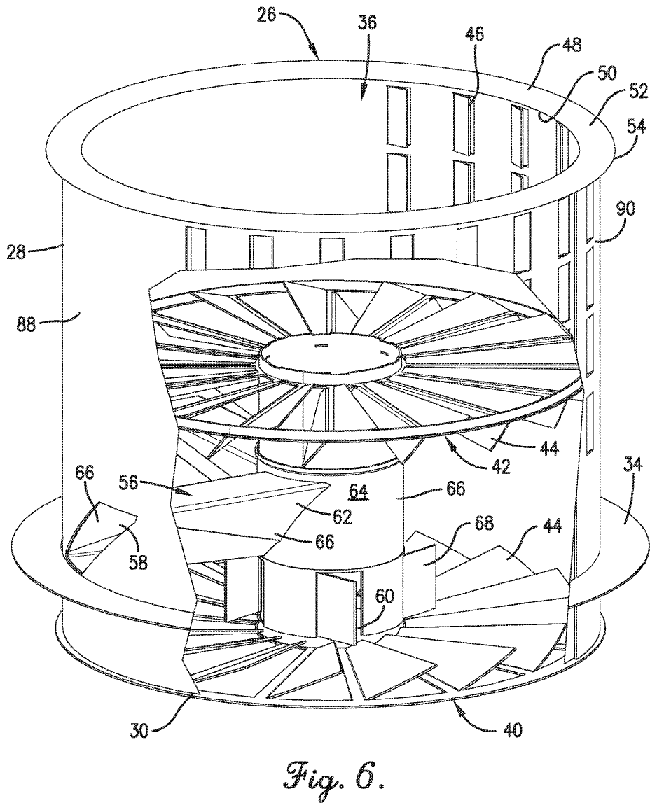

As can best be seen in FIGS. 5 and 6, each can 26 includes at least one tunnel 56 that may be positioned in an upstream side of the can 26 and is constructed to provide a passageway to deliver liquid from the tray deck 24 onto the lower swirler 40 within the can 26, where it interacts with and becomes entrained with the swirling vapor or other fluid stream ascending within the can 26. The tunnel 56 has a tunnel inlet 58 that is positioned at an opening in the outer perimeter wall 28 of the can 26 above the tray deck 24 to allow liquid on the tray deck 24 to enter the tunnel 56 and a discharge outlet 60 that is positioned to discharge descending liquid from within the tunnel 56 onto the lower swirler 40 or into an area adjacent the lower swirler 40.

In one embodiment, the tunnel 56 includes a horizontal segment 62 that extends radially inwardly from the tunnel inlet 58 and a vertical segment 64 that extends downwardly from the horizontal segment 62 at a central position within the can 26. If multiple tunnels 56 are utilized in each can 26, such as the two tunnels 56 illustrated in the drawings, the tunnels 56 may share a common vertical segment 64, with their tunnel inlets 58 being spaced apart a selected circumference distance in the outer perimeter wall 28 of the can 26. A lower edge of each tunnel inlet 58 may be located at the same elevation as an upper surface of the tray deck 24 so that liquid on the tray deck 24 may readily flow into the tunnel inlets 58. The tunnel inlet 58 may be positioned so that it lies below the level of the upper swirler 42 within the can 26.

Each tunnel 56 is formed by one or more outer walls 66 that form an enclosure that defines the tunnel 56 and shields the liquid flowing through the tunnel 56 from the swirling vapor or other fluid stream ascending within the can 26. Because the tunnel 56 lies in the flow path of the swirling vapor or other fluid stream, the outer wall 66 in the horizontal segment 62 that faces against the swirling vapor or other fluid stream may be sloped in the direction of swirling to reduce its impact on the swirling motion. In one embodiment, the outer walls 66 of the horizontal segment 62 of the tunnel 56 may form a parallelogram in cross section that leans in the direction of centrifugal swirling, such as illustrated in the drawing figures.

The discharge outlet 60 of each tunnel 56 may be in the form of directional louvers 68 that are arranged for imparting a directional flow to the liquid in a direction of the centrifugal swirling when the liquid is delivered from the discharge outlet 60 and onto or above the lower swirler 40. The directional louvers 68 may be arranged in one embodiment in the vertical segment 64 of the tunnel 56, with a bottom end of the vertical segment 64 being closed to force all of the descending liquid within the tunnel 56 to exit through the directional louvers 68.

Each contact tray 22 also includes one or more downcomers 70 that deliver liquid from the contact tray 22 to an underlying one of the contact trays 22, normally the adjacent underlying contact tray 22. The downcomer 70 may have various forms and generally extend downwardly from a downcomer inlet 72 positioned at an inlet opening 74 on the tray deck 24 of the contact tray 22 to a discharge outlet 76 that is positioned above an inlet area 78 on the underlying contact tray 24. The inlet area 78 on the underlying the contact trays 24 may be horizontally offset from the downcomer inlet 72 on the overlying contact tray 24. The inlet area 78 is positioned on the tray deck 24 outside of the cans 26.

In the first embodiment of the contact trays 22 illustrated in FIGS. 1-3 and 8, where two cans 26 are positioned on each tray deck 24, the downcomer 70 may be of generally tubular form with a dogleg portion 80 positioned between vertically extending upper and lower portions 82 and 84, respectively.

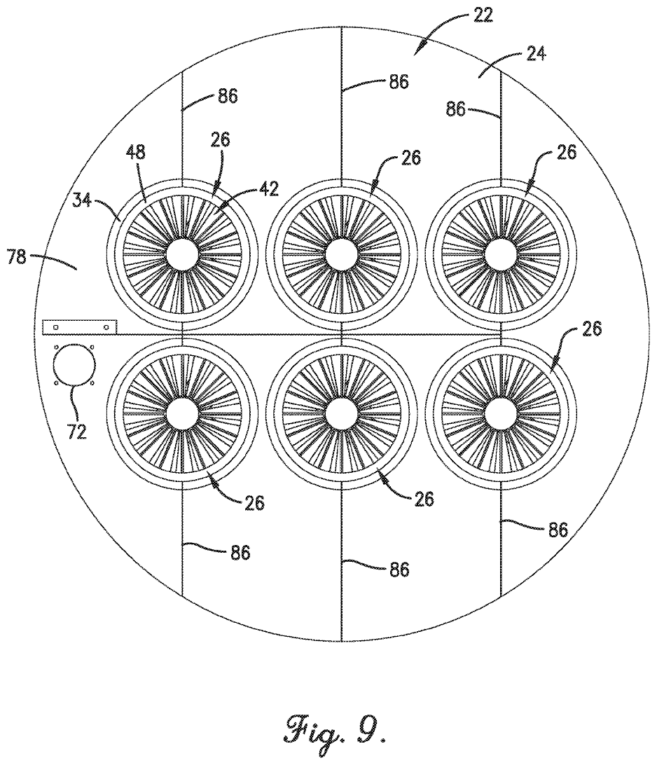

In the second embodiment of the contact trays 22 illustrated in FIG. 9, where six cans 26 are positioned on each tray deck 24, the downcomer 70 is of the same tubular form used with the first embodiment of contact trays illustrated in FIGS. 1-3 and 8.

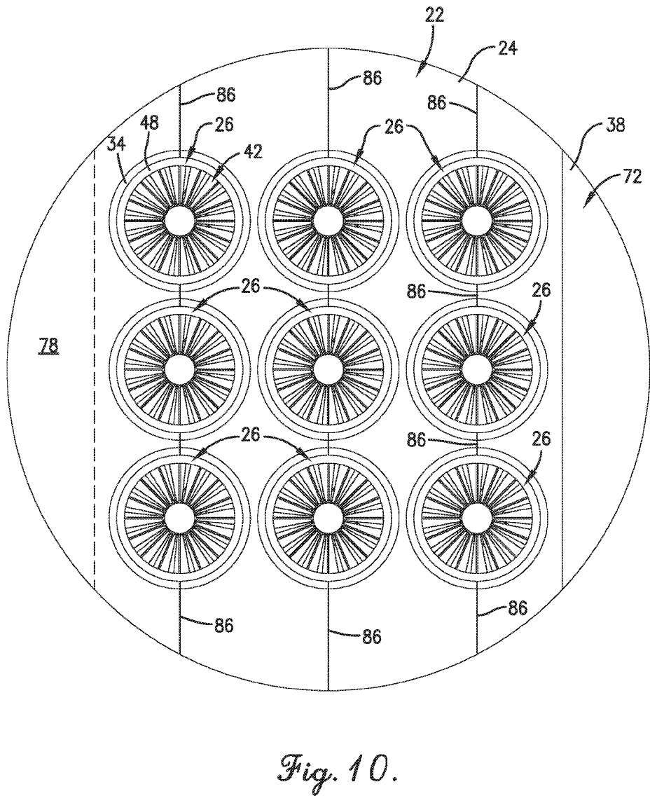

In the third embodiment of the contact trays 22 illustrated in FIG. 10, where nine cans 26 are positioned on each tray deck 24, the downcomer 70 is a chordal downcomer at one end of the tray deck 24, with the inlet area 78 at the opposite end of the tray deck 24 in a single-pass cross-flow tray arrangement.

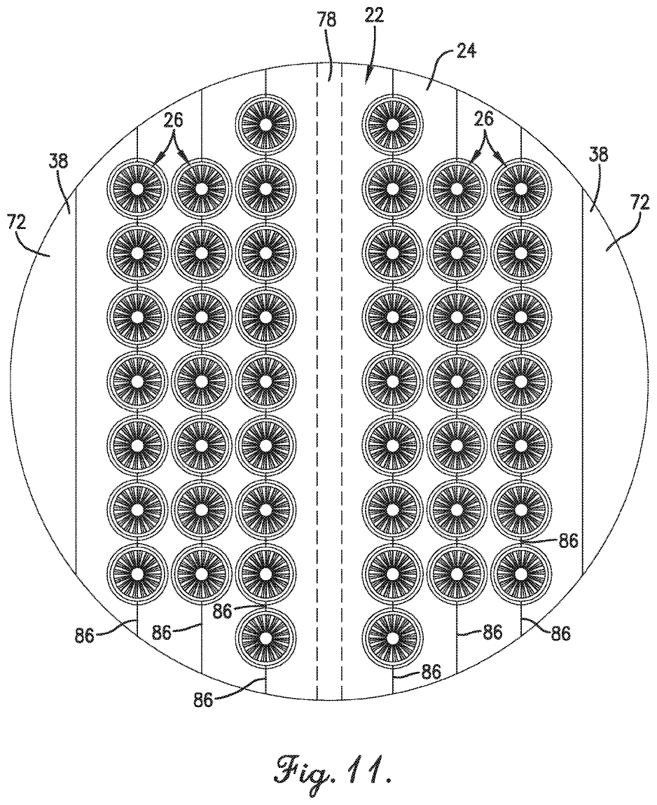

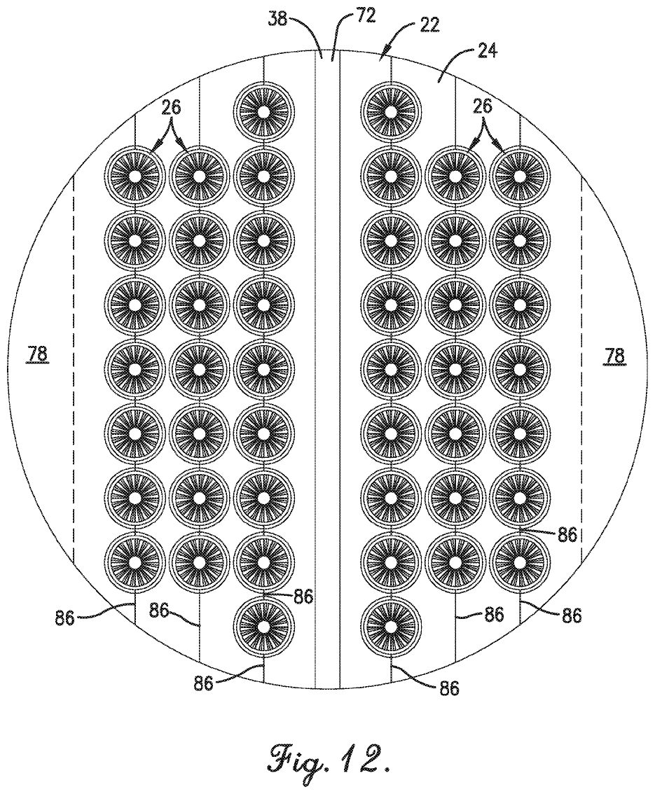

In the fourth embodiment of the contact trays 22 illustrated in FIG. 11, where forty-six cans 26 are positioned on each tray deck 24, two of the downcomers 70 are positioned on opposite ends of the tray deck 24, with the inlet area 78 being centrally positioned between the two downcomers 70 in a center-to-side, two-pass cross-flow tray arrangement. In the fifth embodiment of the contact trays 22 illustrated in FIG. 12, where forty-six cans 26 are also positioned on each tray deck 24, the downcomer 70 is centrally positioned on the tray deck 24 and two inlet areas 78 are positioned at opposite ends of the tray deck in a side-to center, two-pass cross-flow tray arrangement intended to be used in alternating vertical relationship with the center-to-side, two-pass cross flow tray shown in FIG. 11. It is to be understood that other numbers and arrangements and types of the cans 26, the downcomers 70, and the inlet area 78 may be used and are within the scope of the present invention.

An outlet weir (not shown) may be positioned adjacent each downcomer inlet 72 to cause the liquid stream to accumulate to a preselected level on the tray deck 24 before spilling over the outlet weir and entering the downcomer 52. Similarly, an inlet weir (not shown) may be positioned adjacent each inlet area 78 on the tray deck 24 to cause liquid to accumulate to a preselected level on the inlet area 78 before spilling over the inlet weir to flow along the tray deck 24 toward the downcomer inlet 72 on the tray deck 24.

One or more dividing walls 86 extend upwardly from the tray deck 24 on each contact tray 22 and are positioned to direct the liquid when received on the inlet area 78 of the tray deck 24 to the cans 26 for interaction within the cans 26 with the vapor or other fluid steam that has passed upwardly through the openings 38 in the tray deck 26 and then from the cans 26 to the downcomer inlet 72 of the downcomer 70 for delivery to the underlying contact tray 22. The dividing walls 86 are arranged and are of height to block, or substantially impede, the liquid from flowing from the inlet area 78 of the tray deck 24 to the downcomer 72 on the tray deck 26 without first passing through at least one of the cans 26 on the tray deck 26. The dividing walls 86 that contact the cans 26 are arranged to isolate a front or upstream side 88 of each can 26 that contains the one or more tunnel inlets 58 from a back or downstream side 90 of each can 26 that contains the discharge openings 46 in the outer perimeter wall 28 and thereby force the liquid into the one or more tunnels 56 and prevent the liquid from flowing around the can 26 from the upstream side 88 to the downstream side 90.

In the first embodiment of the contact tray 22 shown in FIGS. 1-3 and 8, one of the dividing walls 86 extends between the two cans 26, others of the dividing walls 86 extend from the cans 26 to the shell 12 of the mass transfer column 10, and another dividing wall 86 extends between the shell 12 and the dividing wall 86 that extends between the two cans 26 to separate the downcomer inlet 72 from the inlet area 78 on the tray deck 24. In this arrangement, the liquid flows through the two cans 26 on each tray deck 24 in succession.

In the second embodiment of the contact tray 22 shown in FIG. 9, the dividing walls 86 are arranged so that the liquid flows from the inlet area 78 through each of the six cans 26 in succession before entering the downcomer 70 through the downcomer inlet 72 on the tray deck 24.

In the third embodiment of the contact tray 22 shown in FIG. 10, the dividing walls 86 form three zones or groupings that each contain three cans 26. In this arrangement, the liquid flows from the inlet area 78 through the cans 26 within each grouping of three cans 26 in parallel and then from one grouping of cans 26 to the next in succession before entering the downcomer 70 through the downcomer inlet 72.

Similarly, in the fourth and fifth embodiments of the contact tray shown 22, the dividing walls 86 form multiple groupings that each contain multiple cans 26 and the liquid flows from the inlet area(s) 78 through the cans 26 in each grouping of cans 26 in a parallel fashion and then from one grouping of cans 26 to the next in succession before entering the downcomer(s) 70 through the downcomer inlet(s) on each tray deck 24.

The dividing walls 86 may be planar as illustrated in the drawings, or they may be curved or any other desired configuration. The dividing walls 86 extend upwardly a sufficient distance above the tray deck 24 to maintain the liquid flow along the desired flow path through the cans 26. A top edge of the dividing walls 86 should thus normally be positioned above the uppermost discharge openings 46 formed in the outer perimeter walls 28 of the cans 26. The dividing walls 86 may extend upwardly a sufficient distance to place the top edge of the dividing walls 86 into contact with the overlying tray deck 24 to provide additional support for the tray deck 24 and to ensure proper spacing between adjacent tray decks 24. If the dividing walls 86 contact the overlying tray deck 24, vapor openings (not shown) may be provided near the top edge of the dividing walls 86 to allow the vapor stream to pass through the dividing walls 86 to equalize the pressure across the cross section of the mass transfer column 10.

During use of the mass transfer column 10, a first fluid, which is normally a liquid stream, flows along the tray deck 24 on one contact tray 22 and is delivered into the downcomer inlet 72 and descends through the downcomers 70 before exiting through the discharge outlet 76 onto the inlet area 78 of the (adjacent) underlying contact tray 22. The first fluid then flows from the inlet area 78 along the tray deck 24 and into the cans 26 through the tunnel inlet 58 in the outer perimeter wall 28 of the cans 26. The first fluid then flows downwardly in the tunnel 56 and is discharged onto the lower swirler 40 or into an area above the lower swirler 40. The discharged first fluid then interacts in the can 26 with a second fluid, which is normally a vapor stream, that ascends through the tray deck 24 and the lower swirler 40. The lower swirler 40 and upper swirler 42 impart a centrifugal swirling motion to the second fluid and the discharged first fluid to cause intimate mixing thereof. The centrifugal forces cause the first fluid to impact against an inner surface of the outer perimeter wall 28 where it rises until it encounters the discharge openings 46 in the outer perimeter wall 28. The first fluid is then removed from the inner surface of the outer perimeter wall 28 through the discharge openings 46 in the cans 26 after the interaction with the second fluid, which is removed through the open top 36 of the can 26. The first fluid that is removed from the can 26 is directed onto the tray deck 24 and delivered to the downcomer inlet 72 to repeat the process described above on the next underlying contact tray 22.

### ADDITIONAL CONSIDERATIONS

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

In the specification and claims, reference will be made to several terms, which shall be defined to have the following meanings. The singular forms “a,” “an,” and “the” include plural references unless the context clearly dictates otherwise.

Approximating language, as used herein throughout the specification and the claim, may be applied to modify any quantitative representation that could permissibly vary without resulting in a change in the basic function to which it is related. Accordingly, a value modified by a term or terms, such as “about” and “substantially” are not to be limited to the precise value specified. In at least some instances, the approximating language may correspond to the precision of an instrument for measuring the value. Range limitations may be combined and/or interchanged. Such ranges are identified and include all the sub-ranges contained therein unless context or language indicates otherwise.

As used herein, the terms “axial” and “axially” refer to directions and orientations extending substantially parallel to a center longitudinal axis of the mass transfer column 10. The terms “radial” and “radially” refer to directions and orientations extending substantially perpendicular to the axis. The term “tangential” refers to directions and orientations tangential to the axis. The term “rotational” refers to directions and orientations in a rotational direction and orientation around the axis. Moreover, directional references, such as “side” and similar terms are used herein solely for convenience and should be understood only in relation to each other.

The terms “coupled,” “attached to,” and the like refer to both direct coupling, fixing, or attaching, as well as indirect coupling, fixing, or attaching through one or more intermediate components or features, unless otherwise specified herein.

Although the present application sets forth a detailed description of different embodiments, it should be understood that the legal scope of the description is defined by the words of the claims and equivalent language. The detailed description is to be construed as exemplary only and does not describe every possible embodiment because describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. The foregoing statements in this paragraph shall apply unless so stated in the description and/or except as will be readily apparent to those skilled in the art from the description.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

Although the disclosure has been described with reference to the embodiments illustrated in the attached figures, it is noted that equivalents may be employed, and substitutions made herein, without departing from the scope of the disclosure as recited in the claims.

What is claimed is:

1. A contact tray for facilitating contact between ascending and descending fluids within a mass transfer column, said contact tray comprising:
a tray deck;
two or more cans positioned on and extending upwardly from the tray deck, each of said cans having a generally open top and being formed by an outer perimeter wall of a preselected height from a lower end to an upper end, said outer perimeter wall having a plurality of discharge openings extending through the wall to allow fluid to pass outwardly through the wall from within the can;
openings extending through the tray deck within areas circumscribed by each of the cans to allow fluid to pass upwardly through the tray deck within the cans;
a lower swirler positioned to cause centrifugal swirling of the fluid as it passes upwardly within the cans;
a downcomer extending downwardly from the tray deck and comprising a downcomer inlet formed by an inlet opening in the tray deck outside of the areas circumscribed by the cans for removing liquid from the tray deck and conveying it downwardly and a lower discharge outlet for removing the liquid from the downcomer;
an inlet area on the tray deck outside of the areas circumscribed by the cans for receiving liquid when discharged onto the tray deck from above;
at least one tunnel constructed to provide a passageway to deliver liquid from the tray deck onto the lower swirler, the tunnel having a tunnel inlet that is positioned at an opening in the outer perimeter wall of the can above the tray deck to allow liquid on the tray deck to enter the tunnel and a discharge outlet that is positioned to discharge descending liquid from within the tunnel adjacent the lower swirler to interact with the centrifugally-swirling fluid; and
one or more dividing walls extending upwardly from the tray deck and positioned to direct the liquid when received on the inlet area of the tray deck to the tunnel inlets of the cans and then from the cans to the downcomer inlet of the downcomer.

2. The contact tray of claim 1, wherein the lower end of each can is positioned below the tray deck and the lower swirler in each can is positioned at least partially below the tray deck.

3. The contact tray of claim 2, including an upper swirler positioned within each can above the at least one tunnel to cause additional centrifugal swirling of the fluid that has passed upwardly through the tray deck and into the cans and the liquid that has been delivered from the lower discharge outlet of the tunnel.

4. The contact tray of claim 3, including directional louvers associated with the discharge outlet of each tunnel and arranged for imparting a directional flow to the liquid in a direction of the centrifugal swirling when the liquid is delivered from the discharge outlet.

5. The contact tray of claim 4, wherein the tunnel includes an outer wall facing against and sloped in a direction of the centrifugal swirling.

6. The contact tray of claim 5, wherein each of the cans has two or more of the tunnels extending radially inwardly from the outer perimeter wall of the can and the tray deck is generally planar.

7. The contact tray of claim 1, wherein the tunnel inlets are positioned at an upstream front side of each can and the plurality of discharge openings extending through the outer perimeter wall of each can are positioned in a downstream back side of each can, and wherein the dividing walls isolate the front side of each can from the back side of each can to block the liquid on the tray deck from flowing around each can from the front side to the back side and cause the liquid to enter the tunnel inlets in each of the cans.

8. The contact tray of claim 7, wherein the two or more cans comprise two or more groupings of multiple cans and the dividing walls isolate the front side of each can from the back side of each can in each grouping of cans to allow parallel flow of the liquid on the tray deck into each can in each grouping of cans and to block the liquid on the tray deck from flowing around the cans in each grouping of cans.

9. A mass transfer column comprising:
an upright external shell that defines an open internal region; and
a plurality of horizontally-extending contact trays of claims 1 positioned in vertically-spaced relationship within the open internal region.

10. The mass transfer column of claim 9, wherein the lower end of each can is positioned below the tray deck and the lower swirler is positioned in each can at least partially below the tray deck.

11. The mass transfer column of claim 10, including an upper swirler positioned within each can above the at least one tunnel to cause additional centrifugal swirling of the fluid that has passed upwardly through the tray deck and into the cans and the liquid that has been delivered from the lower discharge outlet of the tunnel.

12. The mass transfer column of claim 11, including directional louvers associated with the discharge outlet of each tunnel and arranged for imparting a directional flow to the liquid in a direction of the centrifugal swirling when the liquid is delivered from the discharge outlet.

13. The mass transfer column of claim 12, wherein the tunnel includes an outer wall facing against and sloped in a direction of the centrifugal swirling.

14. The mass transfer column of claim 13, wherein each of the cans has two or more of the tunnels extending radially inwardly from the outer perimeter wall of the can and the tray deck is generally planar.

15. The mass transfer column of claim 9, wherein the tunnel inlets are positioned in an upstream front side of each can and the plurality of discharge openings extending through the outer perimeter wall of each can are positioned in a downstream back side of each can, and wherein the dividing walls isolate the front side of each can from the back side of each can to block the liquid on the tray deck from flowing around each can from the front side to the back side and cause the liquid to enter the tunnel inlets in each of the cans.

16. The mass transfer column of claim 15, wherein the two or more cans comprise two or more groupings of multiple cans and the dividing walls isolate the front side of each can from the back side of each can in each grouping of cans to allow parallel flow of the liquid on the tray deck into each can in each grouping of cans and to block the liquid on the tray deck from flowing around the cans in each grouping of cans.

17. A method of operating a mass transfer column comprising an upright external shell that defines an open internal region and a plurality of horizontally-extending contact trays positioned in vertically-spaced relationship within the open internal region, each of said contact trays comprising a tray deck, a plurality of cans extending upwardly from the tray deck, a downcomer extending downwardly from the tray deck and having a downcomer inlet at said tray deck, and dividing walls that extend upwardly from the tray deck and isolate an upstream front side of each can from a downstream back side of each can to block fluid on the tray deck from flowing around each can from the front side to the back side, said method comprising the steps of:
delivering a first fluid downwardly through the downcomer extending downwardly from one of said contact trays and discharging the first fluid from said downcomer onto an inlet area on a tray deck of an underlying contact tray;
flowing the first fluid from the inlet area along the tray deck and into the cans through a tunnel having a tunnel inlet that is positioned at an opening in an outer perimeter wall of each of the cans above the tray deck;
flowing the first fluid in the tunnel downwardly and discharging it from the tunnel onto or adjacent lower swirler;
interacting with a swirling motion the first fluid discharged from the tunnel with a second fluid that ascends through the tray deck and the lower swirler within the cans on said underlying contact tray;
removing said first fluid from said cans after interaction with said second fluid; and
directing said removed first fluid from the one or more cans and delivering it to the downcomer inlet.

18. The method of claim 17, wherein said first fluid is a liquid stream and said second fluid is a vapor stream.

19. The method of claim 17, wherein the first fluid flows in succession through the cans on each tray deck.

20. The method of claim 17, wherein the first fluid flows in parallel through the cans on each tray deck.
